(19) United States
(12) Patent Application Publication
(10) Pub. No.: US 2003/0201893 A1
(43) Pub. Date: Oct. 30, 2003

(54) Security fastener and method of securing luggage

(75) Inventors: Loren Redburn, Weymouth, MA (US); Kenneth F. Florek, Colts Neck, NJ (US)

Correspondence Address: Philip E. Roux, Clifford Chance Rogers & Wells LLP, 200 Park Avenue, New York, NY, 10166-0153, US

(73) Assignee: George E. Florek

(21) Appl. No.: 10/422,532

(22) Filed: Apr. 24, 2003

Related U.S. Application Data
(60) Provisional application No. 60/376,458, filed on Apr. 30, 2002.

(51) Int. Cl. G08B 13/14

(52) U.S. Cl. 340/572.8; 40/299.01

(57) ABSTRACT

A fastener for securing an article having a first end terminating in a stop member for substantially permanent insertion into an article, requiring destruction of the fastener for removal, a second end having an enlarged member and a connection member between said first end and said second end, wherein the fastener further comprises means for retaining security information. Also, a method for securing an article, at least a portion of which is made of a material through which a needle can pass, including the step of passing a needle with a stop member of a fastener through the material of the article to be secured, the fastener having a first end terminating in the stop member, a second end having an enlarged member and a connection member between the first end and the second end, wherein removal of the fastener requires destruction of the fastener.

### REFERENCE TO RELATED APPLICATIONS

The present application is based on Provisional Patent Application No. 60/376,458, filed on Apr. 30, 2002.

### FIELD OF THE INVENTION

The present invention relates to the field of security devices and methods and, more particularly, to the area of securing luggage by means which cannot be removed without destruction or evidence of tampering.

### BACKGROUND OF THE INVENTION

Security has become an essential and primary element in travel since terrorist activities have reached the United States. The travel industry has taken a keen awareness to securing luggage so that restricted items and materials are not brought onto planes and the like where they can be used to overtake travel personnel or injure passengers.

It is therefore an object of the present invention to provide a security device and method that can secure a piece of luggage without locking it but provides visual indication of removal or tampering.

### SUMMARY OF THE INVENTION

These and other objects are achieved by the present invention, directed to a security fastener and method of securing luggage comprising a fastener for securing a closure device to the luggage itself so that the luggage closure device cannot be opened without destruction, visual indication or the inability to reattach the fastener.

The security fastener preferably has a first end that passes through the luggage closure and into the luggage and a second end having an enlarged portion which prohibits the second end from passing through the closure and maintains the closure device in a particular location where the fastener is inserted into the luggage. The fastener is preferably a standard tag fastener secured on the luggage using a device such as a standard tagging gun having a needle end which is inserted through an opening on the closure and into the luggage material or luggage seam where the first end of the fastener is embedded.

In the preferred embodiment the security fastener includes a separate label or tag being capable of receiving identification information.

Also in a preferred embodiment, the security fastener includes a security identification feature such as radio frequency or magnetic technology that can be traced or even tracked by security personnel incorporated into the fastener or a tag attached to the luggage by the fastener.

### BRIEF DESCRIPTION OF THE DRAWINGS

The following drawings, in which like reference characters indicate like parts, are intended only to illustrate the preferred embodiments of the invention without limiting the invention in any manner whatsoever, wherein:

FIG. 1 is a perspective view of the fastener being secured onto piece of luggage.

FIG. 2 is a perspective view of the preferred fastener of the present invention.

FIG. 3 is a perspective view of the preferred embodiment of the fastener of the present invention securing the closure of a piece of luggage in a closed configuration.

FIG. 4 is a perspective view of an alternative embodiment of the present invention where the closure device is fastened to the luggage by securing it to another cooperating closure device on the luggage.

### DETAILED DESCRIPTION OF THE PREFERRED EMBODIMENT

As shown in the drawings, the present invention is directed to a security fastening device and method of securing a piece of luggage. The fastener can be in any form suitable of securing a luggage closure device into fixed relation to a portion of the luggage but incapable of removal without destruction, visual indication or the inability to reattach the fastener.

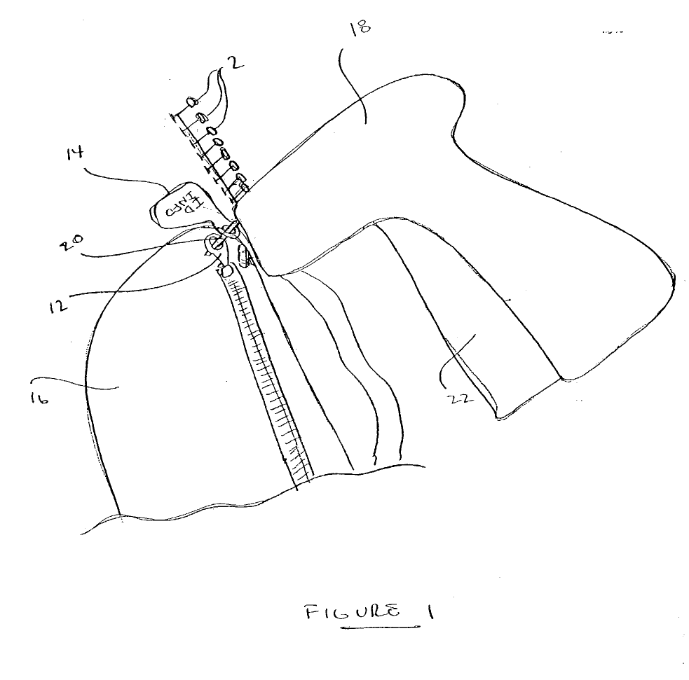

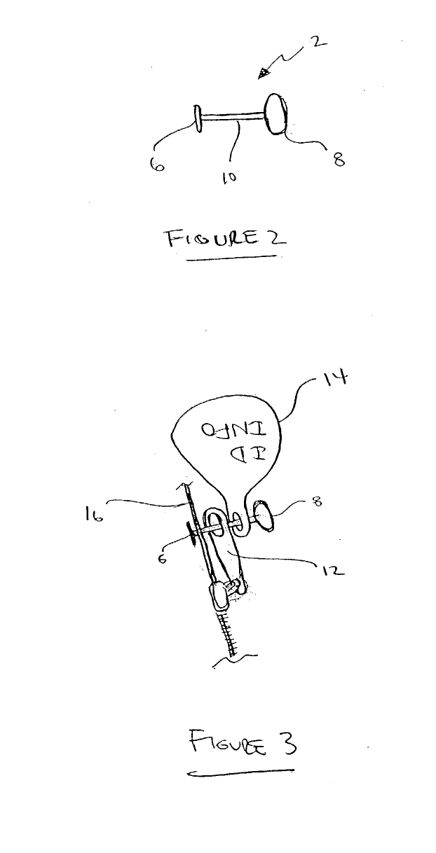

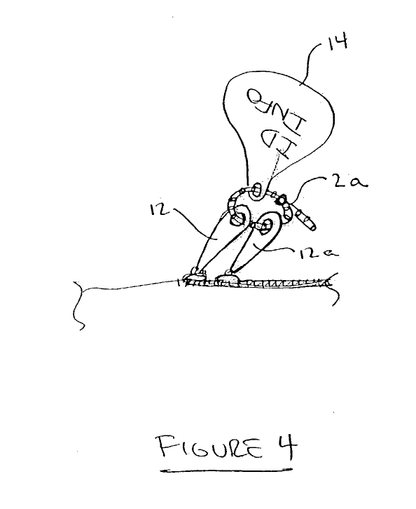

In a preferred embodiment shown in FIG. 2, the fastener 2 preferably comprises a body having a first end with a T-shaped member 6 and a second end with an enlarged member 8 with a connection member 10 therebetween. The T-shaped member 6 is capable of insertion through an opening in a luggage closure device, such as a zipper 12, optionally through a security identification tag 14, and into the material or a seam of a piece of luggage 16 to be secured (see FIGS. 1 and 3).

The fastener 2 of the preferred embodiment shown in FIGS. 1-3 is preferably a plastic tag fastener as known in the art of clothing tagging and secured by a tagging gun 18, also well known in the clothing tagging art. Although a variety of such tagging guns and fasteners are available, suitable devices include the TACH-IT® tagging gun and fasteners available from Interstate Label Company and the PAXAR 3000 Series Tag Attacher available from Monarch Marketing Systems, Inc. of Miamisburg, Ohio. Such tagging guns 18 include a needle 20 and trigger 22 for attaching the fastener 2, wherein the needle 20 passes through the material or a seam of an item and the trigger 22 is then depressed to embed the T-shaped portion 6 of the fastener through the material.

The identification or security tag 14 can be a standard tag with passenger identification information either entered by the passenger or a luggage attendant or can contain security information such as that a piece of luggage has been searched and by whom, where the luggage is destined, etc., in written, bar code or other coded or uncoded form. In a variation, the tag 14 a separate hanging item or a portion of the fastener 2 itself can contain coded information in the form of radio frequency, magnetic or other identification technology which is or will become known in the security art for tracking the secured luggage 16. Preferably, however, the tag 14 would be reinforced at least in the area of the hole which accepts the connection member 10 of the fastener 2.

In the preferred method to secure a piece of luggage 16 using the fastener of FIGS. 1-3 described above, security personnel having a tagging gun 18 passes the needle 20 of the gun through the hole of a zipper 12, optionally through a security or identification tag 14, and into the piece of luggage 16. In a piece of luggage 16 made of a woven or porous material, such as nylon or cotton duffel bags, ballistic nylon luggage or back packs, the needle 20 can be inserted directly through the material an can be inserted through the seam of a piece of luggage 16 made of leather, vinyl or the like. In any event, the needle 20 is inserted into a portion of the piece of luggage 16 in the area of the closed zipper 12. Once inserted into the material or seam of the luggage 16, the security person depresses the trigger 22 and embeds the T-shaped portion 6 of the fastener into the luggage.

Once the T-shaped portion 6 of the fastener 2 is embedded in the luggage 16, the zipper 12 cannot be opened without breaking the fastener 2. When a tag 14 is used with the fastener 2, the tag 14 will not be secured to the bag 16 and will therefore alert security personnel that the luggage 16 is no longer secure.

The size and dimensions of the fastener 2 can be any that suits the purpose of the present invention. For luggage 16 made of a nylon material with a zipper that lays flat on the material and a thin reinforced identification tag 14, a ½ or ¾ inch fastener available from Interstate Label Company would be suitable. Of course, in particular circumstances other sizes could be used. Additionally, it is contemplated that for additional security the fasteners 2 can be made in a variety of colors or have enlarged ends 8 in a variety of shapes. Thus, a particular travel location, such as a particular airport, can change the color or shape of the fastener 2 on a daily or suitable basis to ensure that unauthorized persons cannot affix their own fasteners 2.

In an alternative embodiment, shown in FIG. 4, the fastener 2a is secured to itself through another portion of the luggage 16 other than through the material or a seam. In this embodiment, the fastener 2a can be a Tagger Loc available from Paxar Corporation under item no. Y06-006 (127 mm length) or item no. Y06-008 (203 mm length). The self attaching fastener 2a is attached similar to the straight fastener 2 but must pass through not only the closure device of a piece of luggage 16 but also through another portion of the luggage, such as a cooperating zipper 12 as shown in FIG. 4 or through a loop or the like often found in the vicinity of the closed zipper.

The method of attaching the alternative fastener 2a is very similar to the method of attaching the straight fastener 2, however, the end of the fastener 2a is inserted into an opening on the fastener 2a rather than into the material or seam of the luggage. Of course, a security or identification tag 14 can be used with the self-engaging fastener 2a.

The security aspect of the identification tag of the present invention ensures that a third party will not be able to access the contents of a compartment when out of the owner's control or control of security personnel. Additionally, security officials such as airport personnel will be able to know that once an item was checked and secured, other persons have not had access to the interior of the luggage 16.

Of course, changes, modifications and variations to the above obvious to those skilled in the art can be made without deviating from the present invention. All such changes, modifications, variations and the like are intended to fall within the spirit and scope of this present invention.

1. A security fastener comprising a first end terminating in a stop member for substantially permanent insertion into an article, requiring destruction of the fastener for removal, a second end having an enlarged member and a connection member between said first end and said second end, wherein the fastener further comprises means for retaining security information.

2. The security fastener of claim 1 wherein the stop member comprises a T-shaped member for insertion into an article.

3. The security fastener of claim 1 wherein the means for retaining security information is taken from the group consisting of writing, printing, pre-printed labels, bar codes, radio frequency technology, magnetic technology.

4. The security fastener of claim 3 wherein the means for retaining security information is incorporated into at least a portion of a separate tag having an aperture through which the fastener passes.

5. The security fastener of claim 3 wherein the means for retaining security information is incorporated into at least a portion of the enlarged member.

6. A method of securing an article, at least a portion of which comprises a material through which a needle can pass, comprising the step of passing a needle with a stop member of a fastener through the material of the article to be secured, said fastener comprising a first end terminating in the stop member, a second end having an enlarged member and a connection member between said first end and said second end, wherein removal of said fastener requires destruction of the fastener.

7. The method of claim 6 wherein the fastener further comprises means for retaining security information is taken from the group consisting of writing, printing, preprinted labels, bar codes, radio frequency technology and magnetic technology.

8. The method of claim 6 further comprising the steps of passing the stop member of the fastener through a zipper of the article prior to passing the stop member through the material of the article.

9. The method of claim 6 farther comprising the step of passing the stop member through a security or identification tag prior to passing the stop member through the material of the article.

10. The method of claim 6 further comprising the step of adding security information to the fastener prior to passing the stop member through the material of the article.

11. The method of claim 6 further comprising the step of searching an article prior to passing the stop member through the material of the article.
